(19) United States
(12) Patent Application Publication
(10) Pub. No.: US 2018/0266361 A1
(43) Pub. Date: Sep. 20, 2018

(54) AIRCRAFT GAS TURBINE HAVING A VARIABLE OUTLET NOZZLE OF A BYPASS FLOW CHANNEL

(71) Applicant: Rolls-Royce Deutschland Ltd & Co KG, Blankenfelde-Mahlow (DE)

(72) Inventor: Frank Uwe KOEPF, Blankenfelde-Mahlow (DE)

(21) Appl. No.: 15/762,815

(22) PCT Filed: Dec. 1, 2016
(86) PCT No.: PCT/EP2016/079484

§ 371 Date: Mar. 23, 2018

(30) Foreign Application Priority Data
Dec. 9, 2015 (DE) 10 2015 224 701.5

(51) Int. Cl. F02K 1/08; B64D 27/16; B64D 31/06

(52) U.S. Cl. CPC F02K 1/08; F05D 2220/323; B64D 31/06; B64D 27/16

(57) ABSTRACT

An aircraft gas turbine having a core engine and having a bypass flow channel which surrounds said engine and which forms, with a casing of the core engine and a radially outer housing wall, an outlet nozzle, characterized in that, in the region of the outlet nozzle, there is arranged a ring-shaped element which is able to be displaced in the axial direction, wherein a ring-shaped channel which is able to be varied by way of the displacement of the ring-shaped element is formed between the casing of the core engine and the ring-shaped element.

### DESCRIPTION

The invention relates to an aircraft gas turbine as per the features of the preamble of claim 1.

Specifically, the invention relates to an aircraft gas turbine having a variable outlet nozzle of a bypass flow channel. As known from the prior art, the bypass flow channel surrounds the core engine.

Variable outlet nozzles of bypass flow channels are required in particular in aircraft gas turbines with high bypass rates in order to optimize the degree of efficiency of the fan. By changing the effective outlet area of the outlet nozzle, it is possible for the operating point of the fan to be adjusted such that favorable pressure conditions, which take into consideration the surge limit of the fan, are obtained.

A wide variety of configurations of adjustable outlet nozzles are already known from the prior art. US 2009/0208328 A1 and US 8,850,824 B2 present designs in which elements which can be formed to be curved are arranged on the casing of the core engine in the region of the outlet nozzle. Consequently, it is possible to reduce the cross-sectional area of the outlet nozzle. US 2008/0163606 A1 presents a similar design. In this design too, a wall element, which is arranged on the outer wall of the outlet nozzle and allows a partial amount of the air stream to be diverted toward the surroundings, is formed to be curved.

U.S. Pat. No. 4,043,508 A presents a solution in which a multi-element flap mechanism is used. Here, three flaps are connected in series so as to be pivotable with respect to one another and are able to be pivoted into different positions in order to achieve different outlet areas. Multiple such flap arrangements are provided around the circumference of the outlet nozzle.

The US documents US 2010/0043394 A1 and U.S. Pat. No. 3,598,318 A present a further measure for varying the outlet area of the outlet nozzle. Here, individual flaps which, in different flight states, are pivoted into the bypass flow channel are provided in a manner distributed around the circumference.

As per US 2009/0067993 A1, the cross section of the outlet nozzle may also be influenced in that an outer end region of the casing of the bypass flow channel is displaced in the axial direction.

In the case of the described designs, there is the problem overall that the presented mechanisms are technically complex and are thus costly, and moreover susceptible to faults, in production and in maintenance. A further disadvantage results from the fact that the flow conditions in the bypass flow channel can be influenced in an unfavorable manner.

It is the object of the invention to provide an aircraft gas turbine of the type mentioned in the introduction, which, while being of simple construction and being producible in a simple, low-cost manner, allows effective and flow-optimized adjustment of the outlet nozzle of the bypass flow channel.

The object is achieved according to the invention by the combination of features of claim 1, and the dependent claims show further advantageous configurations of the invention.

It is thus provided according to the invention that, in the region of the outlet nozzle, there is arranged a ring-shaped element which is able to be displaced in the axial direction, wherein a ring-shaped channel which is able to be varied by way of the displacement of the ring-shaped element is formed between the casing of the core engine and the ring-shaped element.

According to the invention, a preferably aerodynamically designed ring is used, which is able to be axially displaced in a manner dependent on the respective flight states or operating conditions of the aircraft gas turbine. Here, the ring-shaped element is designed such that a ring-shaped channel, through which part of the flow of the bypass flow channel is guided, opens between the ring-shaped element and the outer casing of the core engine. Here, in a preferred configuration of the invention, it is provided that the ring-shaped channel opens if the ring-shaped element is displaced to the rear in the axial direction. The term “axial direction” relates to the engine axis within the context of the invention. When the additional ring-shaped channel, which forms an additional part of the bypass flow channel, is opened by way of displacement of the ring-shaped element to the rear, it is self-evident that the ring-shaped channel is able to be completely closed by way of complete displacement of the ring-shaped element to the front.

In a favorable configuration of the invention, it is possible to displace the ring-shaped element into different displacement positions and to fix said element therein. Consequently, the effective outlet cross section of the outlet nozzle can be matched in a simple manner to the operating conditions of the aircraft gas turbine, and, in particular in aircraft gas turbines having a high bypass ratio, matched to the respective operating point of the fan. It is thus possible for the power of the aircraft gas turbine and in particular of the fan to be optimized.

According to the invention, the displacement of the ring-shaped element is not limited to specific displacement positions, but rather it is possible to bring the ring-shaped element into arbitrary displacement positions in a stepless manner.

As a result of the ring-shaped element according to the invention, in comparison with the known designs from the prior art, the possibility of optimizing the flow conditions in the region of the outlet nozzle of the bypass flow channel is opened up. Since the ring-shaped element extends around the entire circumference of the outlet nozzle, the result is uniform flow conditions around the entire circumference. This is not possible in the case of flap solutions known from the prior art, in which individual flaps are distributed separately around the circumference.

A further essential advantage of the invention is also that the mechanism for displacing the ring-shaped element is preferably able to be arranged and integrated on the core engine or the radially outer casing of the core engine such that the flow of the bypass flow channel itself is not disturbed. It is in this case particularly advantageous if the ring-shaped element is able to be displaced by means of electrical or hydraulic actuators. Consequently, lever designs or the like, as presented in the prior art, are not required.

In a favorable configuration, the ring-shaped element is, in cross section, aerodynamically designed and optimized such that minimum pressure loss occurs in the bypass flow channel. This too leads to an increase in the degree of efficiency in the respective positioning of the ring-shaped element.

According to the invention, the ring-shaped element may be designed such that, when being displaced axially, it opens or closes only the additional ring-shaped channel, while the outflow area of the original outlet nozzle remains unchanged. However, it is also possible for the ring-shaped element to be formed in cross section such that the outlet cross section of the original outlet nozzle likewise changes. The “cross-sectional area of the original outlet nozzle” is to be understood as meaning that cross section which is obtained radially outside the ring-shaped element between the ring-shaped element and the outer housing wall. The above-mentioned change or enlargement of the effective outlet area of the outlet nozzle thus comprises the effective area of the additionally provided ring-shaped channel together with the outlet area of the actual original outlet nozzle. The effective cross-sectional area is thus obtained by adding the cross-sectional area of the ring-shaped channel which is to be additionally opened.

The control of the displacement of the ring-shaped element may be realized in an automatic manner by the electronic engine regulation, with the result that the respective engine conditions, for example maximum thrust during the take-off, end of the climbing flight and cruise flight, are automatically taken into consideration.

As a result of the invention, it is thus possible for the aircraft gas turbine to be operated at all times with an optimized fan operating line, and therefore for the respective operating point of the fan to be taken into consideration in a particularly simple and favorable manner, since the different, arbitrarily settable displacement positions of the ring-shaped element lead to different cross sections of the additional ring-shaped channel, with the result that the total effective outlet area of the outlet nozzle can be optimized in a stepless manner.

In a particularly favorable refinement of the invention, it is provided that an additional oil cooler is arranged in the ring-shaped channel. Said cooler is installed for example on the casing of the core engine. The opening or the closing of the additional ring-shaped channel results in the air quantity which is guided through the oil cooler being determined. It is thus possible, for example at a maximum take-off power of the aircraft gas turbine, at which power the additional ring-shaped channel, which is obtained by the displacement of the ring-shaped element, is opened completely, for optimized oil cooling to be realized.

Below, the invention will be described on the basis of an exemplary embodiment in conjunction with the drawing. In the figures:

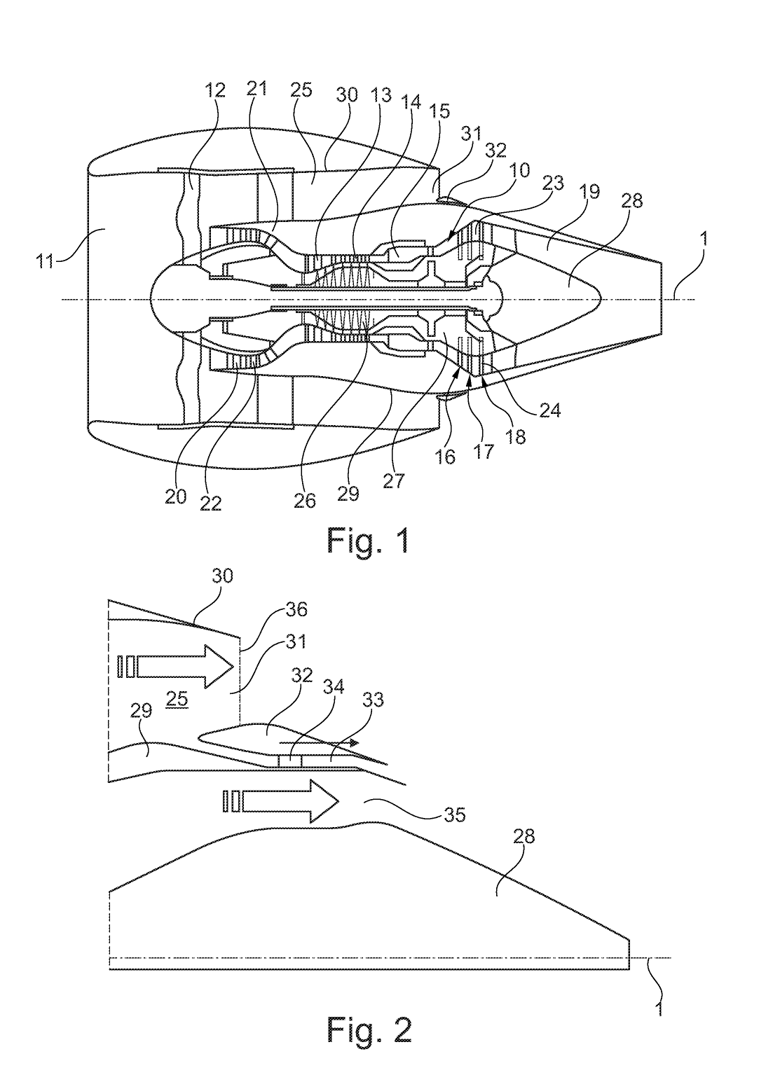

FIG. 1 shows a schematic illustration of a gas turbine engine according to the present invention,

FIG. 2 shows an enlarged detail illustration of an exemplary embodiment in a first operating position with maximum take-off power,

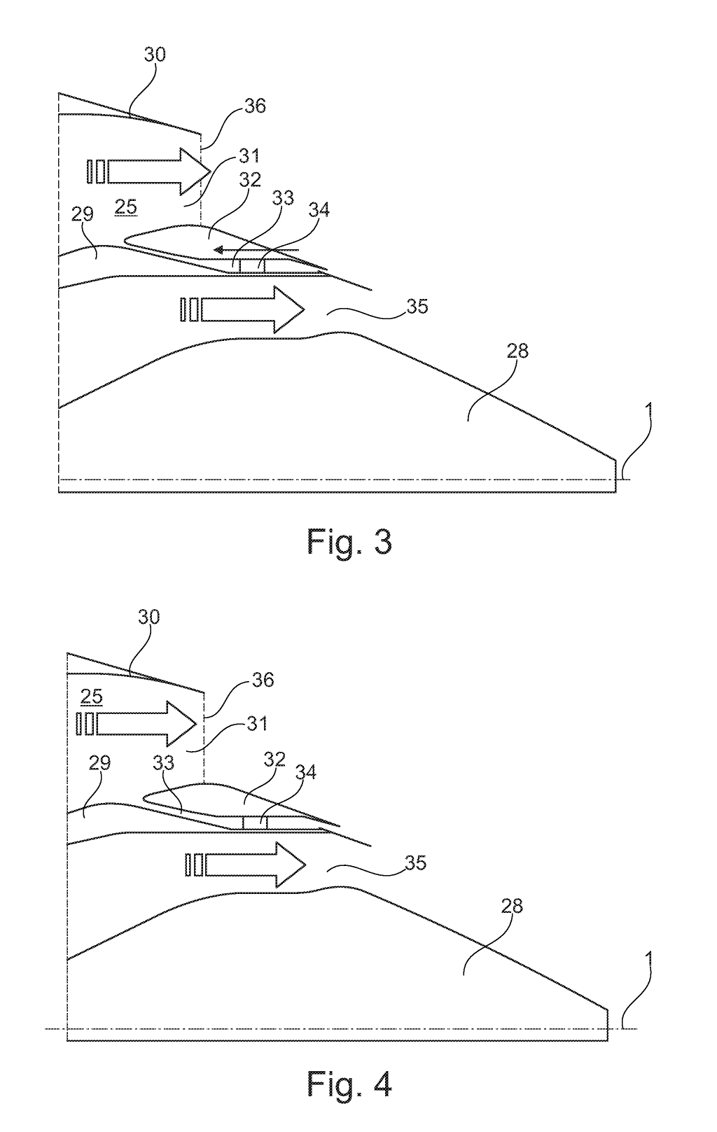

FIG. 3 shows an illustration, analogous to FIG. 2, in an operating position at the end of the climbing flight, and

FIG. 4 shows an illustration in an operating position during cruise flight.

The gas turbine engine 10 as per FIG. 1 is a generally illustrated example of a turbomachine to which the invention can be applied. The engine 10 is designed in a conventional manner and comprises, one behind the other in the flow direction, an air inlet 11, a fan 12 which rotates in a housing, a medium-pressure compressor 13, a high-pressure compressor 14, a combustion chamber 15, a high-pressure turbine 16, a medium-pressure turbine 17 and a low-pressure turbine 18, and also an exhaust-gas nozzle 19, all of which are arranged around a central engine axis 1.

The medium-pressure compressor 13 and the high-pressure compressor 14 each comprise multiple stages, each of which has a circumferentially extending arrangement of fixed, stationary guide vanes 20, which are generally referred to as stator vanes and which project radially inward from the core engine housing 21 into a ring-shaped flow channel through the compressors 13, 14. The compressors furthermore have an arrangement of compressor rotor blades 22 which project radially outward from a rotatable drum or disk 26, which are coupled to hubs 27 of the high-pressure turbine 16 or of the medium-pressure turbine 17.

The turbine sections 16, 17, 18 have similar stages, comprising an arrangement of fixed guide vanes 23 which project radially inward from the housing 21 into the ring-shaped flow channel through the turbines 16, 17, 18, and a following arrangement of turbine rotor blades 24 which project outward from a rotatable hub 27. The compressor drum or compressor disk 26 and the blades 22 arranged thereon, and the turbine rotor hub 27 and the turbine rotor blades 24 arranged thereon, rotate about the engine axis 1 during operation.

FIG. 1 shows, in a merely schematically reproduced aircraft gas turbine, that a bypass flow channel 25 is formed between an outer housing wall 30 and a casing 29 of the core engine 10. The air flow delivered by the fan 12 flows through the bypass channel 25 and exits through an outlet nozzle 31, which is also referred to as a cold outlet nozzle in contrast with a hot outlet nozzle 35 of the core engine.

FIG. 1 shows, in a highly simplified schematic illustration, the arrangement and positioning of a ring-shaped element 32 according to the invention.

FIGS. 2 to 4 each show enlarged and more precisely rendered detail views of the ring-shaped element 32 according to the invention. This is designed as an aerodynamically shaped and flow-optimized ring which preferably extends around the entire circumference of the aircraft gas turbine. FIGS. 2 to 4 each show an end region of the outer housing wall 30 and an end region of the casing 29 of the core engine. A subregion of the outlet cone 28 is additionally illustrated. The outlet nozzle 35 of the core engine is formed between the outlet cone 28 and the casing 29 of the core engine. The arrows each show the flow direction.

The reference sign 36 denotes the cross section of the outlet nozzle 31 in simplified form. This outlet area of the cross section 36 forms the actual outlet nozzle 31, which can remain unchanged when the ring-shaped element 32 according to the invention is displaced. However, it is also possible for the ring-shaped element 32 to be formed in cross section such that, when it is axially displaced, parallel to the engine axis 1, the effective cross-sectional area of the actual outlet nozzle 31 is also able to be varied. The arrow shows the flow through the bypass flow channel 25.

FIG. 2 shows an operating state in which the ring-shaped element 32 according to the invention has been displaced to the rear to a maximum extent in relation to the throughflow direction of the aircraft gas turbine. Consequently, a ring-shaped channel 33 is opened between the surface of the casing 29 of the core engine 10 and the ring-shaped element 32. It is possible for an oil cooler 34 to be arranged in the ring-shaped channel 33.

FIG. 2 shows an operating position in which, in addition to the cross section 36, the effective total area of the outlet nozzle 31 is enlarged by the cross-sectional area of the ring-shaped channel 33. This can result in an enlargement of the total area of 10%. This position is intended at maximum take-off power. The relatively large total effective cross-sectional area allows the operating point of the fan 12 to be lowered, and so a relatively large total power of the aircraft gas turbine is obtained.

In the operating state shown in FIG. 3, the ring-shaped element 32 has, at the end of the climbing flight, been displaced such that a reduction by, for example, 5% of the effective total area of the outlet nozzle 31 is obtained. Here, in contrast with the operating state in FIG. 2, the oil cooler 34 is not, or is only insignificantly, flowed through since the ring-shaped channel 33 is substantially closed.

FIG. 4 shows an operating state during cruise flight, in which the effective total area of the outlet nozzle 31 is determined by a partial opening of the ring-shaped channel 33 such that a target state in which no change occurs is achieved. It should once again be noted at this point that the effective total area of the outlet nozzle 31 results from the respective effective outflow area of the ring-shaped channel 33 and the cross-sectional area 36 of the outlet nozzle 31 in the region of the bypass flow channel 25.

The invention is not limited to the exemplary embodiment shown, but rather numerous possible variations and modifications result within the context of the invention. These may concern both the drive of the ring-shaped element, which drive is not specifically represented, and the cross-sectional configuration and aerodynamic design of the ring-shaped element 32 and of the associated wall of the casing 29 of the core engine.

### LIST OF REFERENCE SIGNS

Engine axis
Gas turbine engine/core engine
Air inlet

### Fan

Medium-pressure compressor (compressor)
High-pressure compressor
Combustion chamber
High-pressure turbine
Medium-pressure turbine
Low-pressure turbine
Exhaust-gas nozzle
Guide vanes
Core engine housing
Compressor rotor blades
Guide vanes
Turbine rotor blades
Bypass flow channel
Compressor drum or disk
Turbine rotor hub
Outlet cone
Casing of the core engine
Housing wall
Outlet nozzle
Ring-shaped element
Ring-shaped channel
Oil cooler
Outlet nozzle of the core engine
Cross section of the outlet nozzle

1. An aircraft gas turbine having a core engine and having a bypass flow channel which surrounds said engine and which forms, with a casing of the core engine and a radially outer housing wall, an outlet nozzle, characterized in that, in the region of the outlet nozzle, there is arranged a ring-shaped element which is able to be displaced in the axial direction, wherein a ring-shaped channel which is able to be varied by way of the displacement of the ring-shaped element is formed between the casing of the core engine and the ring-shaped element.

2. The aircraft gas turbine as claimed in claim 1, wherein the ring-shaped element is able to be displaced into different displacement positions.

3. The aircraft gas turbine as claimed in claim 2, wherein the different displacement positions form different cross sections of the ring-shaped channel.

4. The aircraft gas turbine as claimed in claim 1, wherein the ring-shaped element is designed as a flow body.

5. The aircraft gas turbine as claimed in claim 1, wherein the casing of the core engine is formed to be flow-optimized in the region of the ring-shaped element.

6. The aircraft gas turbine as claimed in claim 1, wherein at least one oil cooler is arranged in the ring-shaped channel.

7. The aircraft gas turbine as claimed in claim 6, wherein the oil cooler is able to be automatically switched in operation or out of operation by way of the displacement of the ring-shaped element.

8. The aircraft gas turbine as claimed in claim 1, wherein the ring-shaped element is able to be displaced parallel to the engine axis.

9. The aircraft gas turbine as claimed in claim 1, wherein the ring-shaped element is able to be displaced by means of electrical or hydraulic actuators.

10. The aircraft gas turbine as claimed in claim 1, wherein the ring-shaped element is mounted on the core engine.
